(19) United States
(12) Patent Application Publication
(10) Pub. No.: US 2026/0236275 A1
(43) Pub. Date: Aug. 13, 2026

(54) ARTIFICIAL INTELLIGENCE-BASED SYSTEMS FOR GENERATING PERSONALIZED INFORMATION

(71) Applicant: TEACHERS INSURANCE AND ANNUITY ASSOCIATION OF AMERICA, New York, NY (US)

(72) Inventors: Sunil Kommirshetty, Basking Ridge, NJ (US); Shafiq N. Kassam, Lewisville, TX (US); Tushaar Bedi, Concord, NC (US); Anil Navani, Watchung, NJ (US); Ajit I. Naidu, Wyckoff, NJ (US)

(21) Appl. No.: 19/051,943

(22) Filed: Feb. 12, 2025

(51) Int. Cl. G06F 9/451

(52) U.S. Cl. CPC G06F 9/451

(57) ABSTRACT

Systems and methods for intelligent generation of personalized information are provided. Example techniques may include receiving an indication of user input associated with a user account during an authorized user session within a service or application provided by a product or service provider. The techniques can include generating a first language model prompt that includes identification information of the user account and a request for additional identifying information associated with the user account. The techniques can include generating a second language model prompt. The second language model prompt can include at least a portion of the additional identifying information received in response to the first language model prompt and a request for personalized information associated with the additional identifying information.

### FIELD OF THE INVENTION

The present disclosure generally relates to technologies for predicting user needs, and, more particularly, to technologies for utilizing artificial intelligence to personalize the information that is presented to users of a system.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Increasingly, consumers perform many day-to-day tasks online, and vast amounts of potential consumer information is available to businesses via data collection. For example, many consumers use online services to research products or to perform planning for future events. Service providers can better serve consumers by leveraging this data collection and personalizing the information provided to consumers on provider websites or elsewhere. However, it can be difficult to dynamically adjust the information provided. Furthermore, online systems present security risks when these systems access provider-proprietary servers and data storage. Accordingly, there are opportunities for improved platforms and technologies for providing personalized service recommendations or education while maintaining consumer privacy and security of service provider systems and data.

### SUMMARY

In one aspect, a computing system includes: (1) one or more processors and (2) a memory that includes computer-executable instructions that, when executed, cause the computing system to receive, via the one or more processors, an indication of user input associated with a user account during an authorized user session; generate, via the one or more processors, a first language model prompt, the first language model prompt including (i.) identification information of the user account, and (ii.) a request for additional identifying information associated with the user account; transmit, over a network interface, the first language model prompt; receive, via the one or more processors, a response to the first language model prompt, the response including the additional identifying information; and generate, via the one or more processors, a second language model prompt, the second language model prompt including (i.) at least a portion of the additional identifying information received in response to the first language model prompt, and (ii.) a request for personalized information associated with the additional identifying information.

In another aspect, a computer-implemented method for generating personalized information includes: (1) receiving an indication of user input associated with a user account during an authorized user session, (2) generating a first language model prompt, the first language model prompt including (i.) identification information of the user account and (ii.) a request for additional identifying information associated with the user account, (3) transmitting the first language model prompt, receiving a response to the first language model prompt, the response including the additional identifying information, and (4) generating a second language model prompt, the second language model prompt including (i.) at least a portion of the additional identifying information received in response to the first language model prompt, and (ii.) a request for personalized information associated with the additional identifying information.

In another aspect, a non-transitory computer-readable storage medium includes instructions that, when executed on a processor, cause the processor to (1) receive an indication of user input associated with a user account during an authorized user session, (2) generate a first language model prompt, the first language model prompt including identification information of the user account and a request for additional identifying information associated with the user account, (3) transmit the first language model prompt to an artificial intelligence (AI) interface, (4) generate a second language model prompt, the second language model prompt including at least a portion of the additional identifying information received in response to the first language model prompt and a request for personalized information associated with the additional identifying information, and (4) output the personalized information, received over the AI interface in response to the second language model prompt, to a display.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computing environment in which the techniques disclosed herein may be implemented, according to an embodiment;

FIG. 2A illustrates a second user display that can be produced according to an embodiment;

FIG. 2B illustrates a third user display that can be produced according to an embodiment; and

FIG. 3 depicts a flow diagram of an exemplary computer-implemented method for generating personalized information, according to some embodiments.

While the systems and methods disclosed herein can be embodied in many different forms, they are shown in the drawings and will be described herein in detailed specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein are not limited in their application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The embodiments described herein relate to, inter alia, methods and systems for providing personalized recommendations or education to users of a computing system.

Service providers often provide services and related products online. Service providers typically have large amounts of information pertaining to their users and account holders that the providers collected during account initiation or other interactions with the users/account holders. Aspects of the present disclosure address conventional challenges discussed above by providing artificial intelligence (AI)-based methods and systems to deliver personalized information to a user (e.g., an account holder).

The present techniques address challenges in conventional systems by providing a process based on generative AI (e.g., a language model such as a large language model (LLM) or another language model). In addition, a prompt module is provided on top of the generative AI to limit access to the generative AI and to help control how provider data and user data are accessed.

### Exemplary Computing Environment

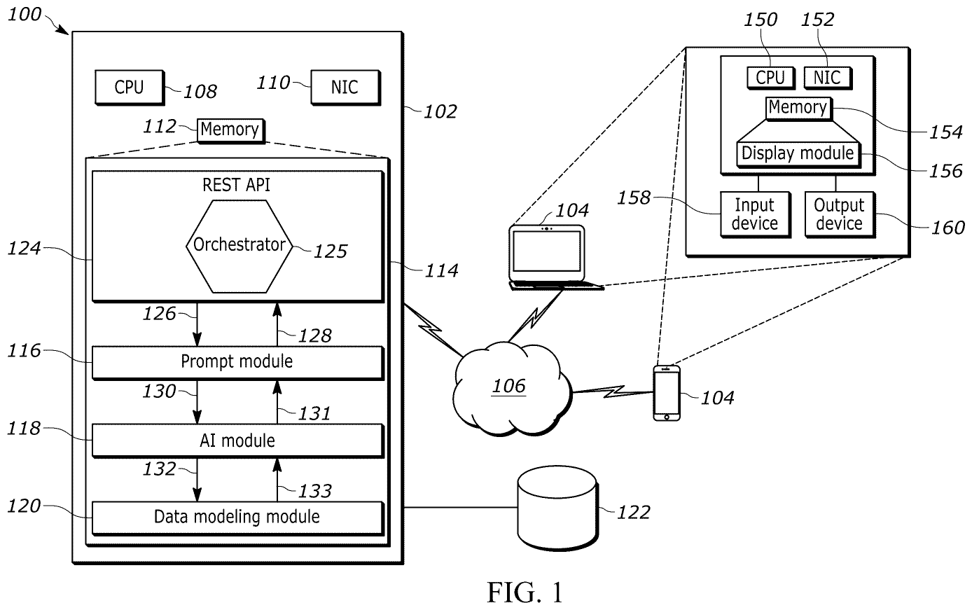

FIG. 1 illustrates an exemplary computing environment 100 in which techniques disclosed herein may be implemented, according to an embodiment.

The environment 100 includes a provider computing device 102, a client computing device 104, and a network 106. Some embodiments may include a plurality of provider computing devices 102 and/or a plurality of client computing devices 104.

The provider computing device 102 may be an individual server, a group (e.g., cluster) of multiple servers, or another suitable type of computing device or system (e.g., a collection of computing resources). For example, the provider computing device 102 may be any suitable computing device (e.g., a server, a laptop, a desktop computer, etc.). In some embodiments, one or more components of the provider computing device 102 may be embodied by one or more virtual instances (e.g., a cloud-based virtualization service). In such cases, one or more provider computing device 102 may be included in a remote data center (e.g., a cloud computing environment, a public cloud, a private cloud, and the like.).

The provider computing device 102 may include a processor 108 and a network interface controller (NIC) 110. In some aspects, the one or more processor 108 may include any number of processors and/or processor types, such as central processing units (CPUs), graphics processing units (GPUs), field-programmable gate arrays (FPGAs), application-specific integrated circuits (ASICs), digital signal processors (DSPs), neural processing units, RISC-V processors, coprocessors, specialized processors/accelerators for artificial intelligence (AI) or machine learning (ML)-specific applications, one or more microcontrollers, and the like.

The provider computing device 102 may include a memory 112. Generally, the processor 108 is configured to execute software instructions stored in the memory 112. The memory 112 may include volatile and/or non-volatile fixed and/or removable memory, such as read-only memory (ROM), electronic programmable read-only memory (EPROM), random access memory (RAM), erasable electronic programmable read-only memory (EEPROM), and/or other hard drives, flash memory, solid-state drives, optical drives, MicroSD cards, and others. The memory 112 may have stored thereon one or more sets of computer-executable instructions, which can be referred to hereinafter as modules 114. The modules 114 may include a prompt module 116, an AI module 118 and a data modeling module 120. In some aspects, more or fewer modules may be included in the modules 114. In some embodiments, the modules 114 may be part of an application (e.g., a desktop application or a web-based application).

The NIC 110 may include any suitable network interface controller(s), such as wired/wireless controllers (e.g., Ethernet controllers), and facilitate bidirectional/multiplexed networking over the network 106 between the provider computing device 102 and other components of the environment 100 (e.g., another provider computing device 102, the client computing device 104, etc.).

The provider computing device 102 may include data repositories 122. The data repositories 122 can be remote and/or local to the provider computing device 102. The data repositories 122 can include one or more data lakes, one or more data warehouses and information obtained from consumers and other business information.

The one or more modules 114 implement specific functionality. For example, in an embodiment, the prompt module 116 communicates with the client computing device 104 over the network 106. The prompt module 116 is provided on top of the generative AI to limit access to the generative AI and to help control how provider data and user data are accessed between the client computing device 104 and the AI module 118 and/or the data modeling module 120 and/or any other proprietary provider information. In some examples, the prompt module 116 may exchange information with the client device 104 via an application programming interface (API) 124 such as a representational state transfer (REST) API. The API 124 may include an orchestrator 125 that may provide integration and communication between the API 124, the network 106, and the prompt module 116, as well as with any other software modules or hardware not shown in FIG. 1. In some examples, the prompt module 116 may receive know me information via a communication path 126 from the API 124 or orchestrator 125, and the prompt module 116 may provide show me information back to the API 124 or orchestrator 125 via a communication path 128 as discussed in more detail later herein.

In an embodiment, the prompt module 116 may generate language model prompts and provide those prompts over connection 130 to the AI module 118. The prompt module 116 may receive responses generated by the AI module 118 based on evaluating the language model prompts. Examples of such prompts and prompt processing are provided later herein.

In an embodiment, the AI module 118 may evaluate the language model prompts and provide this information to the data modeling module 120 over connection 132. In some examples, the AI module 118 uses a language model such as an LLM that recognizes and generates text evaluate prompts. However embodiments are not limited to LLM and can use other types of language models. In some embodiments, the AI module 118 uses a transformer model architecture with an encoder and decoder to encode and decode prompts (e.g., language model prompts such as first and second language model prompts described herein, or subsequent or other language model prompts). The AI module 118 and the data modeling module 120 may include one or more layers of neural networks that combine to process text and generate output text or predictions.

In an embodiment, the data modeling module 120 can provide the additional information requested by the AI module 118 as will be described with reference to examples later herein. The data modeling module 120 may execute one or more machine learning programs or algorithms that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms used to train the data modeling module 120 may comprise a library or package such as a TENSORFLOW based library, the PYTORCH library, and/or the SCIKIT-LEARN Python library.

In examples, the data modeling module 120 can be trained using personal data sets, retirement product data sets, and the like, to provide education or recommendations, response to prompts, etc. These and other data sets can be provided from the data repositories 122.

The client computing device 104 may be an individual server, a group (e.g., cluster) of multiple servers, or another suitable type of computing device or system (e.g., a collection of computing resources). For example, the client computing device 104 may be any suitable computing device (e.g., a server, a mobile computing device, a smart phone, a tablet, a laptop, a wearable device, etc.). In some embodiments, one or more components of the client computing device 104 may be embodied by one or more virtual instances (e.g., a cloud-based virtualization service). In such cases, one or more client computing devices 104 may be included in a remote data center (e.g., a cloud computing environment, a public cloud, a private cloud, etc.).

The client computing device 104 includes a processor 150 and a network interface controller (NIC) 152. The processor 150 may include any suitable number of processors and/or processor types, such as CPUs and one or more GPUs. Generally, the processor 150 is configured to execute software instructions stored in a memory 154. The memory 154 may include one or more persistent memories (e.g., a hard drive/solid state memory) and stores one or more sets of computer executable instructions/modules such as a display module 156.

The NIC 152 may include any suitable network interface controller(s), such as wired/wireless controllers (e.g., Ethernet controllers), and facilitate bidirectional/multiplexed networking over the network 106 between the client computing device 104 and other components of the environment 100 (e.g., another client computing device 104, the provider computing device 102, etc.).

The client device 104 includes an input device 158 and an output device 160. The input device 158 may include any suitable device or devices for receiving input, such as one or more microphone(s), camera(s), hardware keyboard(s), a hardware mouse, capacitive touch screen(s), and the like. The output device 160 may include any suitable device for conveying output, such as a hardware speaker, a computer monitor, a touch screen, and the like. In some cases, the input device 158 and the output device 160 may be integrated into a single device, such as a touch screen device that accepts user input and displays output. The client computing device 104 may be associated with (e.g., be owned by) a user of a service provided by a service provider, an account holder having an account with the service provider, or the like. As such, the client computing device 104 may capture or receive information such as login or authorization information (provided, for example, using the input device 158), and the client device 104 can provide this information to the provider computing device 102 using, for example, an API (e.g., a REST API).

The client computing device 104 may include instructions that, when executed, cause the client computing device 104 to receive inputs from a user of the client computing device 104, process those inputs, transmit those inputs to the provider computing device 102 via the network 106, receive outputs based on processing of those inputs using a LM or other machine learning models, and display those outputs.

The client computing device 104 includes a display module 156 that includes computer-executable instructions that, when executed, cause one or more GUIs to be displayed in the output device 160 of the client computing device 104. For example, the display module 156 may include instructions for rendering GUIs including information output by the provider computing device 102 (e.g., by the prompt module 116). The display module 156 may construct one or more GUIs and receive/retrieve information received from an API (e.g., a REST API 124) and/or the data repositories 122 or another module 114 of the provider computing device 102.

The network 106 may be a single communication network or may include multiple communication networks of one or more types (e.g., one or more wired and/or wireless local area networks (LANs), and/or one or more wired and/or wireless wide area networks (WANs) such as the Internet). The network 106 may enable bidirectional communication between the provider computing device 102 and the client computing device 104, or between multiple client computing devices or provider computing devices, for example.

In operation, a provider may use the environment 100 to provide personalized information to a user. For example, a user may use the client device 104 to access a service provider system to begin an authorized user session. The API 124 may receive a request from the client computing device 104 over network 106. The prompt module 116 may evaluate a dynamic prompt string using the received request. For example, the prompt may be “Tell me about user $name, DOB=$dob, member number=$member_number” wherein $name, $dob, and $member_number are dynamic variables. The API 124 (or orchestrator 125) may receive values (e.g., member_number=123456) for some or all of these dynamic variables from the client device 104, and interpolate those variables into the prompt string, wherein the interpolation refers to the process of replacing the dynamic variables with the values received via the API 124 and/or retrieved from other sources (e.g., from the data repositories 122). The client computing device 104 may provide the generated prompt and/or values over the communication path 126.

The first language model prompt may include, in addition to other text or information, identification information of the user account such as account number, username, account name, account nickname, and the like. The language model prompt may also include a request for additional identifying information associated with the user account. Continuing with the example, the interpolated prompt (e.g., first language model prompt) can include “Tell me about user John Kennedy, DOB=Jan. 1, 1941, member number=123456.” The first language model prompt can be provided over the connection 130 to AI module 120 and responses to the first language model prompt can be provided over the connection 131.

In response to the first language model prompt, the prompt module 116 may receive additional identifying information from the data modeling module 120 through the AI module 118, over connection 131 and connection 133. For example, the response can include information regarding the age of the account holder, marital status, number of children, salary, other information identifying the account holder's demographics, information identifying the account holder as a member of a group (e.g., a workplace, a social club, etc.). These or other groups can form clusters of account holders based on demographics. In the context of embodiments, clustering account holders by demographics involves grouping individuals based on shared characteristics such as age, gender, income level, education, geographic location, etc. This process enables tailoring services, products, and communications to meet the specific needs of different demographic segments. By understanding the common attributes within a cluster, organizations can predict behaviors, preferences, and needs, enabling them to design more effective marketing strategies, product offerings, and personalized experiences.

Implementing demographic clustering can be achieved through various machine learning techniques. For example, in one aspect, a K-means clustering algorithm may be used to segment users into distinct groups based on their demographic data. The process begins with data preprocessing steps such as cleaning and normalization to ensure the quality and compatibility of the data. Next, the K-means algorithm is applied, where “K” represents the number of clusters to be formed. The algorithm iterates through the data, assigning each user to the nearest cluster based on Euclidean distance until the positions of the cluster centers stabilize. This results in the formation of clusters where users within the same cluster are more similar to each other in terms of their demographic characteristics than those in other clusters. The choice of “K” can be determined using methods such as the elbow method, which involves plotting the within-cluster sum of squares against the number of clusters and selecting the elbow point as the optimal number of clusters. Through this approach, organizations can effectively segment their audience and tailor their strategies to meet the unique needs of each demographic cluster.

Continuing with the example, the response can include “John Smith is 50 years old with four children.” The response can be decoded by the LLM (for example) implemented within the AI module 118.

The prompt module 116 can use the response to the first language model prompt to generate a second language model prompt. The second language model prompt may include at least a portion of the additional identifying information received in response to the first language model prompt and a request for personalized information associated with the additional identifying information. Continuing with the above example, if the response to the first language model prompt was that the account holder is 50 years old with four children, the second language model prompt could be “Recommend or educate on some products for someone who is 50 years old” or “Recommend or educate on some products for someone who has four children” or the like. In example embodiments, the second language model prompt includes a request for investment advice or retirement advice or education, although aspects of this disclosure are not limited thereto.

The AI module 118 may receive the second language model prompt, transform the second language model prompt and provide the transformed second language model prompt to the data modeling module 120. Depending on the data modeling module 120 that is invoked or present, the data modeling module 120 can respond with retirement advice or education for a 50-year-old (using the above example), savings goals or recommendations or education for a 50-year-old, etc. The data modeling module 120 may also provide other recommendations or education related or unrelated to retirement or investment products. The present techniques are not limited to retirement and investment products, although some example aspects discuss those products.

The AI module 118 may provide the result of the second language model prompt to the prompt module 116 and the prompt module 116 may transmit the result (e.g., as text or encoded/encrypted result) to the client device 104 over the network 106. By acting as an intermediary between the client computing device 104 and the AI module 118 or other proprietary provider modules and data, the prompt module 116 provides security to prevent unauthorized access to proprietary systems and/or user data. The prompt module 116 (or specialized encryption modules or encryption accelerators of the provider computing device 102) can execute other functions for security enhancement including encryption and privacy controls.

The prompt module 116 may generate at least one of the first language model prompt or the second language model prompt based on identification of a currently viewable user interface screen associated with the authorized user session. The prompt module 116 can identify the currently-viewable user interface screen using an API call to a web application or a smartphone application provided or hosted by the provider. For example, if a user lands on a profile page while visiting the provider website or application via a mobile device (e.g., the client computing device 104), the prompt module 116 may make API calls and/or receive responses to API calls identifying the currently-active or viewable screen as the user profile screen. The prompt module 116 may then generate prompts based on information provided in the profile page, such as account balance, user zip code, beneficiaries, and the like.

In some embodiments, the prompt module 116 may generate at least one of the first language model prompt or the second language model prompt based on identification of a pending task associated with the user account. For example, the prompt module 116 can detect (e.g., using API calls or responses to API calls, through information stored in data repositories 122, through responses to other language model prompts, etc.) that the corresponding logged-in user has not yet assigned an account beneficiary. In response to detecting this or other condition(s), the prompt module 116 can generate at least one of the first language model prompt or the second language model prompt with the goal of getting the user to assign a beneficiary. For example, a first language model prompt could ask “Does Bob have a beneficiary?” A second language model prompt could be “Give me some recommendations or education for people who do not have a beneficiary,” or similar requests for information.

Systems described herein provide a prompt interface that generates prompts and that generates different types of prompts that may be input into one or more AI models (e.g., a generative AI model, an LLM, etc.) to produce recommendations or education or other personalized information. Because training of the underlying models can occur continuously using updated training data, different or updated recommendations or education can be provided periodically and/or upon detecting changes in a user's demographics (e.g., increase of age, increase in number of children or changes in children ages resulting in reduced numbers of dependents, changes in job or job field that may result in salary changes, etc.) and/or upon detecting different possible recommendations or education that could be provided.

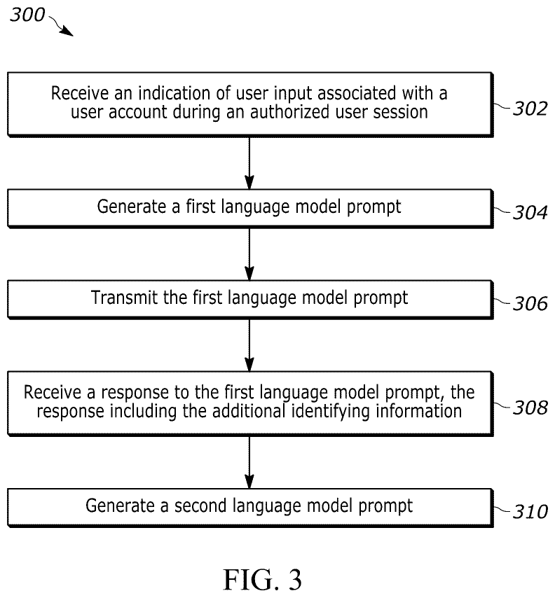

In some examples, any one or more of the modules described above may include instructions for carrying out any of the steps of the steps of methods described herein (e.g., the method 300 which is described in greater detail below with respect to FIG. 3).

### Exemplary Computer-Implemented Graphical User Interfaces

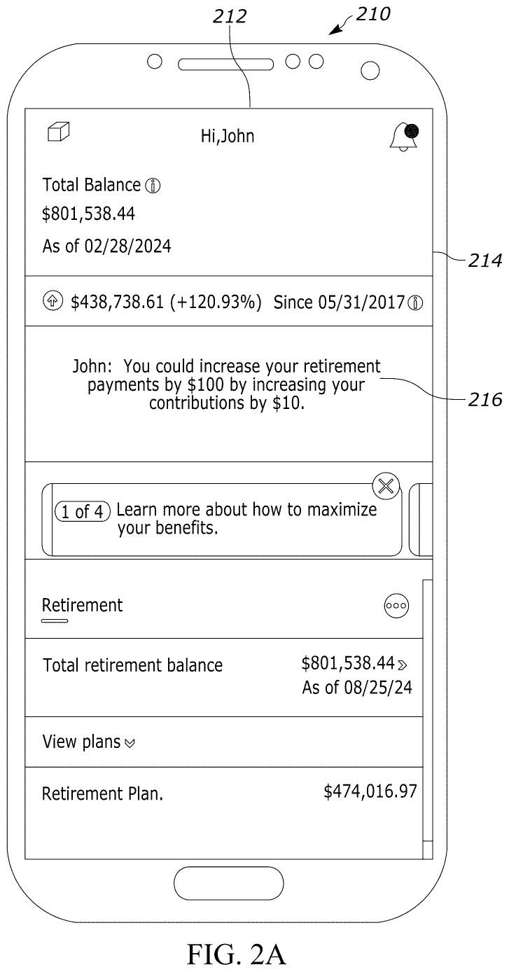

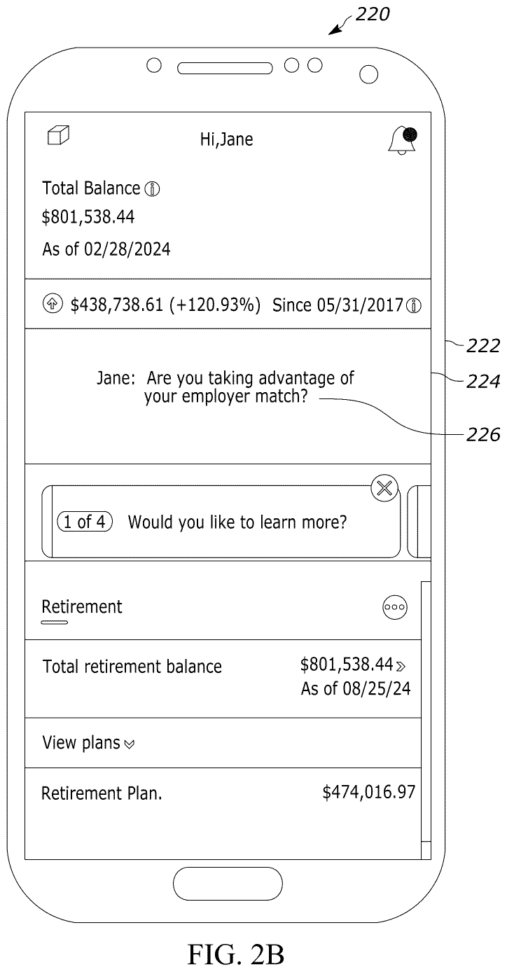

Example displays that may be generated in accordance with the above-described embodiments are depicted in FIGS. 2A-2B. Reference is made to various components of FIG. 1 in describing FIGS. 2A-2B.

FIG. 2A depicts a client computing device 210 that may correspond to the client computing device 104 (FIG. 1). Client computing device 210 may include a screen 212 upon which is displayed a text string 214 including a recommendation or education 216 based on account holder demographic information. The recommendation or education may be obtained through implementation of methods according to various embodiments through communication to the provider computing device 102.

Upon logging in to a retirement account, the client computing device 104 may provide an account number (0123456789) corresponding to the user of to the provider computing device 102, for example, via an authenticated call to the REST API of the provider computing device 102. The REST API 124 may pass the account number to the prompt module 116, which may generate a first language model prompt such as “Tell me about the account holder of account 01234567489.” The prompt module 116 may query the AI module 118 with the first language model prompt.

The AI module 118 may evaluate the first language model prompt provided by the prompt module 116. The AI module 118 may provide the pertinent information to the data modeling module 120, and, continuing with the example prompt input, the data modeling module 120 may respond with additional information about the account holder for account Y. For example, the data modeling module 120 may provide information indicating that the user is twenty-five years old, or that the user is only contributing $100 a month into his retirement account. The AI module 118 may provide a translated response to the prompt module 116. The data modeling module 120 may retrieve information from the data repositories 122 based on the information received from the AI module 118.

The prompt module 116 may use the information identifying the account holder to generate a second language model prompt requesting recommendations or education that could be provided to the user. For example, the prompt module 116 could generate a second language model prompt “Please provide me some recommendations or education for someone who is 25 years old.” The AI module 118 may generate an output sequence based on the second language model prompt and provide the output sequence to the data modeling module 120. The data modeling module 120 may respond to the AI module 118 with a recommendation or education that the user increase his contributions. The AI module 118 can provide a translated response to the prompt module 116. The prompt module 116 may provide the recommendation or education to the client device 104, and the client device 104 may formulate the recommendation or education for display on the GUI.

Turning now to FIG. 2B, a client computing device 220 may correspond to client computing device 104 (FIG. 1). Client computing device 220 may include a screen 222 upon which is displayed a text string 224 including a recommendation or education 226 based on an account holder being a new employee or having other demographic information different from that shown in FIG. 2A.

Upon logging in to a retirement account, the client computing device 104 may provide an account number to the provider computing device 102, for example, via an authenticated call to the REST API of the provider computing device 102. The REST API 124 may pass the account number to the prompt module 116, which may generate a first language model prompt such as “Tell me about the account holder of account Y.” The prompt module 116 may query the AI module 118 with the first language model prompt.

The AI module 118 may evaluate the first language model prompt. The AI module 118 may provide the pertinent information to the data modeling module 120, and, continuing with the example prompt, the data modeling module 120 may respond with additional information about the account holder for account Y. For example, the data modeling module 120 may provide information indicating that the user does not have a retirement account. The AI module 118 can provide a translated response to the prompt module 116. The data modeling module 120 may retrieve information from the data repositories 122 based on the information received from the AI module 118.

The prompt module 116 may use the information identifying the account holder to generate a second language model prompt requesting recommendations or education that could be provided to the user. For example, the prompt module 116 could generate a second language model prompt “Please provide me some recommendations or education for someone who does not have a retirement account.” The AI module 118 may generate an output sequence based on the second language model prompt and provide the output sequence to the data modeling module 120. The data modeling module 120 may respond to the AI module 118 with a recommendation or education that the user increase his contributions. The AI module 118 can provide a translated response to the prompt module 116. The prompt module 116 may provide the recommendation or education to the client device 104, and the client device 104 may formulate the recommendation or education for display on the GUI.

### Example Computer-Implemented Method

FIG. 3 depicts a flow diagram of an exemplary computer-implemented method 300 for generating personalized information, according to one embodiment. One or more operations of the method 300 may be implemented as a set of instructions stored on a non-transitory computer-readable storage medium (e.g., memory 112) and executable on one or more processors (e.g., the processor 108 as described for any of the modules 114 including the prompt module 116, AI module 118, and/or data modeling module 120).

The method 300 may begin with operation 302 with the processor 108 (or, for example the prompt module 116) receiving an indication of user input associated with a user account during an authorized user session. In some examples, the indication can include operating system event notifications or event notifications from other sources that may include one or more user cursor actions, user keystroke actions, and/or user accelerometer actions, during the authorized user session. Furthermore, in some examples, the indication may include information indicating an order of the one or more user cursor actions, user keystroke actions, and/or user accelerometer actions, and/or a time duration of one or more of (or each of) the one or more user cursor actions, user keystroke actions, and/or user accelerometer actions. That is, the indication may include the ways in which (and/or the speed with which) the user types, moves their cursor, navigates a website or application, or otherwise moves their device as they interact with the website or application provided by the service provider.

The method 300 can continue with operation 304 with generating a first language model prompt. The first language model prompt can include identification information of the user account. The first language model prompt can additionally or alternatively include a request for additional identifying information associated with the user account. The additional identifying information can include demographic information, associate the user account with a demographic group or other group, or include any other similar information.

The method 300 can continue with operation 306 with transmitting the first language model prompt. As described with respect to FIG. 3, this transmitting can occur using any wired or wireless connection or interface. The method 300 can continue with operation 308 with receiving a response to the first language model prompt. The response can include the additional identifying information.

The method 300 can continue with operation 310 with generating a second language model prompt. The second language model prompt can include at least a portion of the additional identifying information received in response to the first language model prompt. The second language model prompt can additionally or alternatively include a request for personalized information associated with the additional identifying information. The second language model prompt can include a request for investment advice or retirement advice or education although embodiments are not limited to investment or retirement advice or education, nor are embodiments limited to financial advice or education generally or specifically.

Either or both of the first language model prompt and the second language model prompt can be based on identification of a pending task associated with the user account. Additionally, or alternatively, the first language model prompt and/or the second language model prompt can be based on identification of a currently-viewable user interface screen of the service.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for adaptive intelligent user validation. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computing system comprising:
one or more processors; and
one or more memories, having stored thereon instructions that, when executed, cause the computing system to:
receive, via the one or more processors, an indication of user input associated with a user account during an authorized user session;
generate, via the one or more processors, a first language model prompt, the first language model prompt including (i.) identification information of the user account, and (ii.) a request for additional identifying information associated with the user account;
transmit, over a network interface, the first language model prompt;
receive, via the one or more processors, a response to the first language model prompt, the response including the additional identifying information; and
generate, via the one or more processors, a second language model prompt, the second language model prompt including (i.) at least a portion of the additional identifying information received in response to the first language model prompt, and (ii.) a request for personalized information associated with the additional identifying information.

2. The computing system of claim 1, wherein the second language model prompt includes a request for investment advice or retirement advice or education, and wherein the personalized information corresponds to output of the second language model prompt.

3. The computing system of claim 1, the one or more memories having stored thereon instructions that, when executed, cause the computing system to:
generate a software interface that provides access to a large language model (LLM) transformer.

4. The computing system of claim 3, wherein the software interface accesses trained machine learning models that have been trained using personal data.

5. The computing system of claim 3, wherein the software interface accesses trained machine learning models that have been trained using retirement product datasets.

6. The computing system of claim 1, the one or more memories having stored thereon instructions that, when executed, cause processor to:
generate at least one of the first language model prompt or the second language model prompt based on identification of a currently-viewable user interface screen associated with the authorized user session.

7. The computing system of claim 6, the one or more memories having stored thereon instructions that, when executed, cause processor to identify the currently-viewable user interface screen using an application programming interface (API) call to a web application or a smartphone application.

8. The computing system of claim 1, wherein the additional identifying information associates the user account with a group.

9. The computing system of claim 1, the one or more memories having stored thereon instructions that, when executed, cause the one or more processors to generate at least one of the first language model prompt or the second language model prompt based on identification of a pending task associated with the user account.

10. A computer-implemented method for generating personalized information, the method comprising:
receiving an indication of user input associated with a user account during an authorized user session;
generating a first language model prompt, the first language model prompt including (i.) identification information of the user account and (ii.) a request for additional identifying information associated with the user account;
transmitting the first language model prompt;
receiving a response to the first language model prompt, the response including the additional identifying information; and
generating a second language model prompt, the second language model prompt including (i.) at least a portion of the additional identifying information received in response to the first language model prompt, and (ii.) a request for personalized information associated with the additional identifying information.

11. The method of claim 10, wherein the second language model prompt includes a request for investment advice or retirement advice or education.

12. The method of claim 10 wherein the additional identifying information associates the user account with a group.

13. The method of claim 10, wherein at least one of the first language model prompt and the second language model prompt is generated based on identification of a pending task associated with the user account.

14. The method of claim 10, wherein at least one of the first language model prompt and the second language model prompt is generated based on identification of a currently viewable user interface screen of a provider application.

15. The method of claim 10, further comprising:
generating a software interface that provides access to a large language model (LLM) transformer.

16. A non-transitory computer-readable storage medium including instructions that, when executed on a processor, cause the processor to perform operations including:
receiving an indication of user input associated with a user account during an authorized user session;
generating a first language model prompt, the first language model prompt including identification information of the user account and a request for additional identifying information associated with the user account;
transmitting the first language model prompt to an artificial intelligence (AI) interface;
generating a second language model prompt, the second language model prompt including at least a portion of the additional identifying information received in response to the first language model prompt and a request for personalized information associated with the additional identifying information; and
outputting the personalized information, received over the AI interface in response to the second language model prompt, to a display.

17. The non-transitory computer-readable storage medium of claim 16, wherein the additional identifying information associates the user account with a group.

18. The non-transitory computer-readable storage medium of claim 16, wherein the second language model prompt includes a request for investment advice or retirement advice or education.

19. The non-transitory computer-readable storage medium of claim 16, wherein at least one of the first language model prompt and the second language model prompt is generated based on identification of a pending task associated with the user account.

20. The non-transitory computer-readable storage medium of claim 16, wherein at least one of the first language model prompt and the second language model prompt is generated based on identification of a currently-viewable user interface screen of a provider application.
